(19) United States
(12) Patent Application Publication
(10) Pub. No.: US 2013/0238189 A1
(43) Pub. Date: Sep. 12, 2013

(54) DISPLAY DEVICE AND METHOD FOR DISPLAYING GRAPHICAL OBJECTS, IN PARTICULAR FOR MOTOR VEHICLES

(71) Applicant: VOLKSWAGEN AG, Wolfsburg (DE)

(72) Inventor: Jan MICHAELIS, Berlin (DE)

(73) Assignee: Volkswagen AG, Wolfsburg (DE)

(21) Appl. No.: 13/871,472

(22) Filed: Apr. 26, 2013

Related U.S. Application Data
(63) Continuation of application No. PCT/EP2011/004085, filed on Aug. 13, 2011.

(30) Foreign Application Priority Data
Oct. 26, 2010 (DE) 10 2010 049 720.7

(51) Int. Cl. B60Q 9/00

(52) U.S. Cl. CPC B60Q 9/00
USPC 701/36

(57) ABSTRACT

A display device for a vehicle equipped with a plurality of comfort systems that can be switched on or off is provided. The display device has a display area for displaying graphical objects and a control unit for controlling the display area. The control unit is designed to receive data about consumptions of the comfort systems and to produce graphical data for graphical objects representing the consumptions for the display area from said data. The consumption due to comfort systems is indicated to the driver in an intuitive manner if the graphical object of a switched-on comfort system is designed as a segment of an annular figure.

This nonprovisional application is a continuation of International Application No. PCT/EP2011/004085, which was filed on Aug. 13, 2011, and which claims priority to German Patent Application No. DE 10 2010 049 720.7, which was filed in Germany on Oct. 26, 2010, and which are both herein incorporated by reference.

### BACKGROUND OF THE INVENTION

1. Field of the Invention

The invention relates to a display device for a vehicle, particularly a motor vehicle, equipped with a plurality of comfort systems that can be turned on or off. The device can include a display area for displaying graphical objects and a control unit for controlling the display area, whereby the control unit can be designed to receive data based on the consumptions of the comfort systems and to produce graphical data for the graphical objects representing the consumptions for the display area from the data. The invention relates further to a method for displaying graphical objects on a display area in such a vehicle.

2. Description of the Background Art

Numerous comfort systems, which can be turned on or off by a driver, are installed in modern motor vehicles. The term “comfort system” is to be understood broadly within the context of this invention. Comfort systems are electrically operated systems that are not absolutely necessary for the movement of the vehicle, but are used primarily for the comfort of the occupants. Comfort systems include, for example, a climate control system, window heaters, heated steering wheel, and infotainment systems (e.g., navigation system, radio, CD, DVD, telephone), etc.

Because all these systems are electricity consumers, when turned on they must be run either from a battery or in a running vehicle from an alternator. In vehicles with an internal combustion engine, the alternator in turn is powered by the internal combustion engine. The more current the alternator must provide for the operation of the comfort systems, the higher the engine fuel consumption that proportionally relates to the alternator operation. This basic relationship is familiar to the person skilled in the art, but typically not to the driver himself. The driver turns on the comfort systems when he needs them. At times, however, he forgets to turn off the comfort systems when he no longer needs them. This inevitably results in increased fuel consumption or in a higher load on the battery in the case of electric or hybrid vehicles. Therefore, each turned-on comfort system results in increased power consumption. “Consumption” within the context of this invention is taken to mean a reduction of the power sources (e.g., fuel, battery charge) usable for operation (movement, comfort systems, and the like).

In order to encourage the driver to reduce consumption by turning off no longer required comfort systems, EP 2 028 059 A2, which is incorporated herein by reference, discloses an identification of system-specific consumption levels and displays them on a display device.

### SUMMARY OF THE INVENTION

It is therefore an object of the invention to provide a display device and a method that alert the driver in a simple and intuitive manner of a consumption by comfort systems in order to encourage economical-driving behavior.

In an embodiment, it is provided that a graphical object of a turned-on comfort system is displayed as a segment of a circular figure.

The term “circular figure” is to be understood broadly within the context of this invention, and other shapes may also be utilized. First of all, a circular figure can be a closed circular ring formed by two concentric circles with different radii. Further, a circular figure is an open circular ring which arises from two concentric arcs with the different radii and two curves connecting the arcs at their ends. A circular figure, however, is also formed by two non-overlapping, nested ellipses. The figure formed by ellipses can be closed or open like the circular ring. Other circular figures may be considered, which are formed, for example, from closed or open polygonal traverses or closed or open conical sections. Also, a circular figure can be understood to be also a two-dimensional projection of a three-dimensional shape, for example, a torus.

Via the display device of the invention the driver is provided with simple, comprehensible, and intuitive information about the consumptions of the vehicle comfort systems. The driver is faced with the fact that an actual and optionally also numerically indicated increased consumption is associated with the operation of one or more comfort systems. Based on this descriptive information, the driver can check the turned-on comfort systems as to whether the driver requires them at present; if this is not the case, then the driver will turn them off and reduce the power consumption. Thereby, the present invention represents a meaningful contribution to an increasingly more important economic way of driving.

In an embodiment, the circular figure is configured as a circular ring, because a circular ring can be represented simply as a simple geometric shape and information can be easily read off it.

In an embodiment, an area of the segment is to the area of the circular figure as the consumption of the turned-on comfort system is to the total consumption of all comfort systems. Thereby the driver receives pictorial information, easy to understand even with a glimpse, on the share of power consumption by the viewed turned-on comfort system relative to other comfort systems. The driver can thus be sensitized in a simple way to an environmentally aware use of the comfort systems.

The driver obtains a simple comparability of the turned-on comfort systems in an advantageous manner, when the graphical objects of these comfort systems are configured as segments of a circular figure.

It is advantageous in an embodiment, when optionally the graphical object of just one of the turned-on comfort systems can be displayed on the display area, or the graphical objects of all turned-on comfort systems can be displayed on the display area. In the first case, the driver's focus is directed to the shown comfort system, and in the second case the driver is given a simple overview of which comfort systems are consuming more or less power in comparison with the others. The graphical objects can be shown fixed in a position on the display area; i.e., the display of a graphical object assigned to a specific comfort system can occur in the same place on the display area both in the individual display and in the overall display. This has the great advantage that the driver need not reorient themselves after switching between these displays and can read the information they select rapidly and reliably.

When many comfort systems are turned on, it can be expedient to display only some graphical objects of the turned-on comfort systems substantially simultaneously on the display area. These can be, for example, the comfort systems that currently have the highest energy consumptions, or other predetermined or preset combinations can also be displayed. Alternatively, however, the driver can select the comfort systems to be displayed via a control element. The separate segments can be displayed arranged relative to one another. In a ring-shaped arrangement, for example, the stringing together of the individual separate segments clockwise or counterclockwise is practical.

In an embodiment, the information content can be increased, when apart from the graphical objects alphanumeric information about consumption can be displayed, for example, in a text field on the display area. The alphanumeric information about the consumption can include, for example, numerical data, a unit of measurement, etc. If the display device is provided in a motor vehicle with an internal combustion engine, an exemplary unit during driving is, for example, liters per 100 km (L/100 km) and when stationary, for example, liters per hour (L/h).

For further information for the driver, it is advantageous, when in addition, a symbol (for example, a pictogram) and/or an alphanumeric identifier representing the turned-on comfort system or the turned-on comfort systems is displayed. For example, if the driver were to have set up that only a current consumption of a climate control system is displayed, a symbol representing the climate control system could be displayed on the display area. When an alphanumeric designation is displayed, this could be, e.g., “Climate control system.” Particularly in the case of self-explanatory pictograms or short designations, the driver receives in a quickly understandable manner the information on which comfort system the display on the display area refers to.

In an embodiment, the display device of the invention takes into account consumptions of the most important comfort systems in a vehicle, for example, for the following: climate control system, window opening (possibly separately for each window), sunroof, seat heater (possibly separately for each available seat heater), infotainment (for example, radio, CD, telephone, navigation, etc.), and window heater (possibly separately for each window heater that can be turned on and off separately, for example, a windshield heater, rear window heater, or side window heater).

Advantageously, the display device works together with one or more control elements so that switching is possible between the various pieces of consumption information. The switching is especially convenient for the driver if the control element or elements is/are integrated into a steering wheel or attached to the steering wheel. Suitable control elements can be, for example, buttons, rockers, touchpads, touch screens, etc. In an embodiment, the switching can be performed via voice activation, hand signals, etc.

In order to provide the driver with a consistent display of information on the consumptions of the comfort systems, it is advantageous to display average consumption values, for example, consumptions averaged over predefined time periods. The time periods can also be selected individually for different comfort systems.

The method of the invention has the same advantages as the display device of the invention, so that reference is made to the previous remarks.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic diagram of a motor vehicle of the invention; and

FIGS. 2-6 illustrate several displays on a display area.

### DETAILED DESCRIPTION

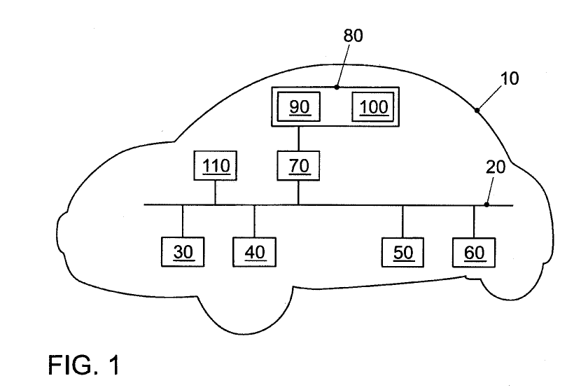

FIG. 1 shows a motor vehicle 10. Motor vehicle 10 has a bus 20, which in the present case is configured as a CAN bus. Comfort systems are connected electrically to bus 20. In the present case, four comfort systems are shown by way of example, namely: a climate control system 30, an electric window opener 40, an electric seat heater 50 for the left front seat, and a seat heater 60 for the right front seat. A device 70 for determining the consumptions of the comfort systems is electrically coupled to bus 20.

Motor vehicle 10 further is equipped with a display device 80. Display device 80 comprises a control unit 90 and a display area 100. Display device 80 is electrically coupled to device 70. Control unit 90 is designed to receive data on consumptions of the comfort systems from device 70 and to produce graphical data for graphical objects 120, 130, 140, 150, 160, representing the consumptions, for display area 100 from said data. Display area 100 is designed as a freely programmable color display, e.g., as an LCD screen. Display device 80 can be integrated into an instrument cluster.

The comfort systems can be turned on or off by a driver via a control element 110. The control signals for turning the comfort systems on and off are sent to the comfort systems via bus 20.

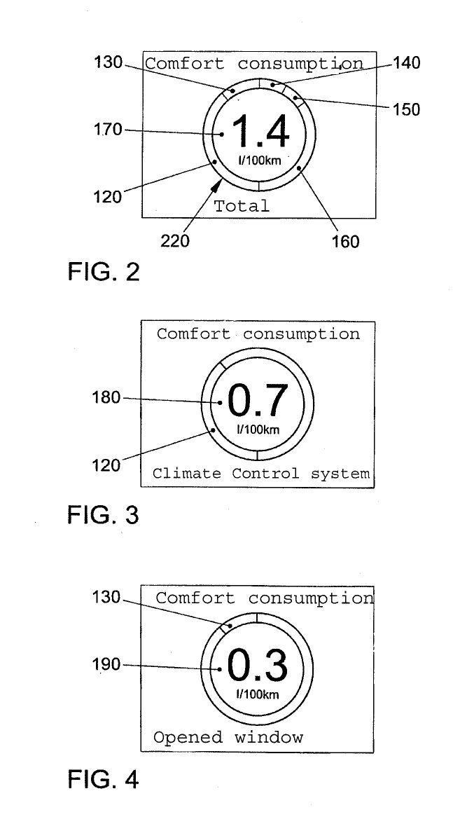

FIGS. 2 to 6 show by way of example graphical objects 120, 130, 140, 150, 160, displayed on display area 100, and alphanumeric information 170, 180, 190, 200.

It is assumed in the below example that climate control system 30, seat heater 50 for the left front seat, and seat heater 60 for the right front seat are turned on. It is assumed, moreover, that the window to be operated by a window opener is partially open.

It can be seen in FIG. 2 that graphical objects 120, 130, 140, 150, 160 are configured as segments of a circular ring 220. In this case, graphical object 120 represents the climate control system, graphical object 130 the open window (therefore the comfort system electric window), graphical object 140 seat heater 60 for the right front seat, and graphical object 150 seat heater 50 the left front seat. Graphical object 160 represents other turned-on comfort systems, which are not broken down, however, but are combined in order not to burden the driver with too much individual information.

The driver has previously selected the comfort systems associated with graphical objects 120, 130, 140, 150. Alternatively, the display device can also have made this selection automatically, for example, in that only four comfort systems are displayed separately that use the most power when more than four comfort systems are turned on. It is noted that more than four systems can also be displayed.

It is evident further in FIG. 2 that a text field with alphanumeric information 230 “1.4 L/100 km” is shown in the center of circular ring 220. This alphanumeric information 230 indicates that the total consumption of the displayed turned-on comfort systems is 1.4 L of fuel per 100 km. Further, the information “comfort consumption” is shown on display area 100 in another text field above circular ring 220, which indicates to the driver that he is in a “comfort consumption” menu. The other information “total” in a text field below circular ring 220 tells the driver that the consumptions of all turned-on comfort systems are being shown to him.

The areas of the ring segments are proportional to the consumptions corresponding to them (also cf. FIGS. 3 to 6 concerning this). Graphical objects 120, 130, 140, 150, 160 are strung together without mutual overlapping and form circular ring 220. Graphical objects 120, 130, 140, 150, 160, moreover, have different graphical depictions; for example, they have different colors and/or patterns (for example, striped, dotted, or checkered).

The driver reaches the displays shown in FIGS. 3 to 6 by a single or repeated operation of control element 110, for example, a rocker on the steering wheel.

In FIG. 3, graphical object 120 is shown visually emphasized compared with the rest of circular ring 220. Graphical object 120 has the same size and position as in FIG. 2. The alphanumeric information “0.7 L/100 km” is provided in the center of circular ring 220; it indicates that the climate control system currently consumes 0.7 L of fuel per 100 km. This information here is only an average value extrapolated to 100 km based on the consumption determined at this time or a consumption determined most recently for a predefined time interval. The words “Climate control system” are shown below circular ring 220; they indicate that the information displayed on display area 100 refers to climate control system 30.

In FIG. 4, graphical object 130 is provided for the consumption due to the opened window as 0.3 L/100 km. Here as well, it can again be easily seen that segment 130 is shown exactly as within the overall display in FIG. 2.

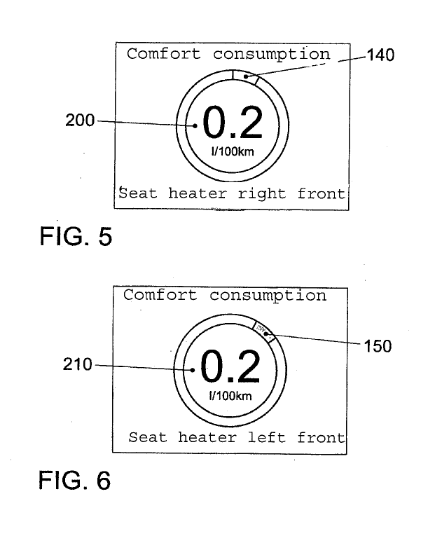

FIG. 5 shows the consumption for seat heater 60 of the right front seat. It is 0.2 L/100 km.

In FIG. 6, finally the consumption for seat heater 50 of the left front seat is provided as 0.2 L/100 km.

The clear displays of the consumptions of the comfort systems enable the driver to read the information rapidly and reliably and encourage him to give some thought to the need for one or more of the turned-on comfort systems. In this way, the consumption information of the invention contributes to a driver's ecological behavior.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A display device for a vehicle having a plurality of comfort systems that are configured to be turned on or off, the display device comprising:
a display area configured to display at least one graphical object; and
a control unit configured to control the display area, the control unit being configured to receive data based on a consumption of at least one comfort system and to produce graphical data for the graphical object representing the consumption for the display area from the data,
wherein the graphical object of a turned-on comfort system is configured as a segment of a circular figure.

2. The display device according to claim 1, wherein the circular figure is configured as a circular ring.

3. The display device according to claim 1, wherein an area of the segment is to an area of the circular figure as the consumption of the turned-on comfort system is to a maximum consumption of all comfort systems or to a total consumption of all comfort systems.

4. The display device according to claim 1, wherein the graphical objects of all turned-on comfort systems are configured as segments of the circular figure.

5. The display device according to claim 1, wherein optionally the graphical object of just one of the turned-on comfort systems is displayed on the display area or the graphical objects of all turned-on comfort systems can be displayed in the display area.

6. A method for displaying graphical objects on a display area in a vehicle equipped with a plurality of comfort systems that can be turned on or off, the method comprising:
receiving data related to a consumption of a comfort system;
generating, based on the data, graphical data for graphical objects representing the consumption; and
selecting the graphical data to be displayed in the display area,
wherein the graphical object of a turned-on comfort system is configured as a segment of a circular figure.

7. The method according to claim 6, wherein the circular figure is configured as a circular ring.

8. The method according to claim 6, wherein an area of the segment is to an area of the circular figure as the consumption of a turned-on comfort system is to a maximum consumption of all comfort systems or to a total consumption of all comfort systems.

9. The method according to claim 6, wherein graphical objects of all turned-on comfort systems are configured as segments of the circular figure.

10. The method according to claim 6, wherein the graphical object of just one of the turned-on comfort systems is displayed on the display area or the graphical objects of all turned-on, comfort systems are displayed on the display area.
